(19) United States
(12) Patent Application Publication
(10) Pub. No.: US 2002/0080827 A1
(43) Pub. Date: Jun. 27, 2002

(54) Buried data stream in a wireless home network

(76) Inventor: Steven K. Lee, Minneapolis, MN (US)

Correspondence Address: Beck & Tysver, P.L.L.C., Suite 100, 2900 Thomas Avenue S., Minneapolis, MN, 55416, US

(21) Appl. No.: 10/028,011

(22) Filed: Dec. 21, 2001

Related U.S. Application Data
(63) Continuation-in-part of application No. 09/746,817, filed on Dec. 22, 2000.

(51) Int. Cl. H04J 3/12

(52) U.S. Cl. 370/527; 370/529

(57) ABSTRACT

A method and apparatus is presented for burying a hidden data stream into a combined network data stream. In the preferred embodiment, the network data stream is an MPEG-2 type video data stream, and the hidden data stream is embedded so that it is neither readily detectable nor easily removable from the network data stream. A home gateway having a wireless transceiver communicates with appliances in the home via this network data stream. The hidden data stream can be embedded with a main data stream either by the content provider or by the gateway in the home. At the appliance, the hidden stream can be removed and is presented to or used by the user in a way appropriate for the appliance. Instructions as to how the hidden stream is to be presented on the appliance can be embedded into the hidden stream itself. The hidden data stream can be further used to control access to and control the content of the rest of the network data stream. Revenue generated by allowing access to the hidden data stream can be utilized to subsidize the cost of the wireless network components.

### CROSS-REFERENCE TO A RELATED APPLICATION

This application claims the benefit of, and incorporates by reference, U.S. patent application Ser. No. 09/746,817, filed Dec. 22, 2000.

### FIELD OF THE INVENTION

The present invention relates generally to the use of an embedded communication channel within a digital communication stream. More specifically, the present invention relates to an embedded data channel that can be controlled and buried within a wireless home network.

### BACKGROUND OF THE INVENTION

For many years, advertising has served as one of the primary financial supports for the development of new media formats. Before the advent of cable television and pay-per-view events, commercial advertisements allowed television services to be provided to the consuming public without charge. The ability to present commercial messages to the public has also supported free radio services, and has greatly reduced the consumer cost of newspapers and magazines.

With the advent of the Internet and the World Wide Web, many attempts have been made to establish a method for effectively presenting commercial messages to Internet users. Banner ads on web site became a ubiquitous part of the Internet within three years of the invention of the graphical web browser. In the beginning, banner ads were considered an effective means of sending commercial messages to Internet users. For instance, much of the initial user base of Amazon.com was attracted by banner ads that seemingly appeared on every commercial web site.

However, as the Internet aged and “click-throughs” on banner ads diminished, advertisers became disenchanted with the ability of banner ads to reach consumers. Advertising rates for banner ads decreased, and advertisers began searching for other ways to reach Internet consumers. Variations on banners ads soon developed, including “pop-up” advertisements that appeared in their own window when a web page was accessed. Some users, many of whom were comfortable with banner ads, considered the pop-up ads to be too intrusive. Thus, pop-up advertisements are not a popular method of Internet advertising. Advertisers are therefore left searching for another method of reaching Internet users through the limited capabilities of the World Wide Web interface.

Both pop-up advertisements and banner ads are generally ordered from web site content providers or their agents. When users request pages from a web site, the site selects an advertisement and presents it to the users. Fees are usually paid to the web site either on a per view or a per click-through basis. Thus, advertisements placed with the web site are valuable only to the extent that users are attracted to the web site. The most valuable sites to advertisers tend to be “portal” web sites, which attract users with a wide array of useful content. Some portal web sites are directly associated with Internet access providers, which allows them to be assigned as the default home pages for users of the access providers.

Unfortunately, advertisements placed via a web site content provider have not been as successful as advertisements in the more traditional media of radio and television. This is most likely due to several concurrent factors. First, there is the customer reaction of ignoring banner ads while simultaneously objecting to pop-up web advertisements. Since advertisements placed on web sites must be transmitted via HTML, Java, or a related language, advertisers are currently left searching for an innovative way to use these languages to reach consumers.

Second, with advertisements placed on a web site, there is no guarantee that the advertisement will be successfully transmitted to the user. Intermediaries between the web site content provider and the end user are in control of the data stream. Internet access providers could use their control of the pipeline to alter or replace advertisement. In addition, Internet users can use sophisticated programs to screen out unwanted advertisements.

Third, there is very little ability to reach a large audience with a single advertising campaign. While Internet portal sites reach larger audiences than other sites, sophisticated uses will change home pages to meet their needs. Thus, even the largest portal sites have been faced with significantly decreased advertising revenue.

Finally, since the web site advertisement paradigm presumes that users will be using the Internet to access an actual web site, these advertisement are not able to be associated with other types of Internet usage. For instance, users that download music files or streams may not even use a web site as an interface to such files. Alternatively, future televisions may directly access video programs through the Internet without first accessing a traditional web page. Users of such technology would therefore not be potential audiences for a web site advertisement. Thus, as more digital content becomes available over the Internet, web site advertisements will become less and less relevant.

Another avenue for presenting advertisements to Internet users is to coordinate the advertisements through the hardware used to interact with the Internet. For instance, several companies have offered free or reduced price computer hardware in exchange for the right to present tailored advertisements to the user. The users agree to provide demographic information about themselves, which allows the hardware providers to sell tailored ads to advertisers at a higher ad rate. Unfortunately, since the advertising stream to the hardware was neither particularly secure nor particularly well integrated with the web sites being viewed, programs were created which “hacked” the hardware and eliminated the advertisements on users' screens.

What is needed then is a new method of linking commercial advertising messages to Internet content. This method should not be dependent on the existence of a web page, and should allow commercial messages to be linked directly to content, either at the source or at the user's location. Ideally, the same method that allows the commercial message to be linked to content could also be used to provide an additional communication channel into the home. This channel could be used selectively, for purposes such as providing commercial messages, increasing bandwidth, providing content relating to the main message, controlling encryption of the main message, or for carrying control signals.

### SUMMARY OF THE INVENTION

The present invention meets these needs by providing a buried data stream that is embedded into a network data stream. This buried data stream can be embedded into a wireless local area network, in which data streams can be transferred from data sources to end user appliances within a home.

In one embodiment of the present invention, the commerce data stream is deeply embedded at a source of digital data. This commerce stream is undetectable until the digital data is decoded in order to be accessed by the end user. At that point, the commerce stream can be removed from the digital data, and can be presented to the user in a way that is appropriate for the digital data.

Video material could be transmitted from its source in an MPEG format or future variants of such a format. Within MPEG encoded data could be a hidden or buried commerce data stream. This hidden stream would not be detectable by any of the entities that control the data stream, including Internet access providers or home broadband entry points. When the data stream enters the home, it would be disseminated through a wireless local area network. A wireless transceiver port on a home appliance would receive that signal. This port would decode the MPEG transmission as appropriate for the appliance, such as into a HDTV signal for a HDTV set. The port would also be able to decode the buried commerce channel. The data in this commerce channel would allow commercial message to then be shared with a user in the manner desired and selected by the advertiser. For instance, a TV like commercial could interrupt the normal MPEG signal. Alternatively, a pop-up advertisement could appear on the screen, or an area of the screen could be reserved for advertisements. Of course, the buried commerce channel should not significantly alter the transmitted data, so that appliances that are incapable of decoding the commerce signal could still present the entire MPEG signal without any significant signal degradation.

In a second embodiment, a gateway with a broad band communication path to the Internet is provided in the home environment. The gateway further acts as a wireless LAN transceiver, or base station. The gateway has access to a source of commercial messages. The gateway then embeds the commercial messages in a buried commerce data pathway hidden within the wireless communication to appliances in the home. A receiver on an appliance receives this wireless communication, and decodes the communication into a regular data path, which contains data received over the Internet through the gateway, and a commerce data path, which includes the commercial messages. The commercial messages are then presented to the user via the appliance in a manner appropriate to the appliance.

In a third embodiment of the present invention, commercial messages on the commerce data paths of embodiment one and two are sold to advertisers. Revenue from the advertising sales are utilized to reduce the cost of the wireless network components.

In a fourth embodiment of the present invention, the buried data stream is utilized selectively to carry an additional communication channel into the home. The channel itself can be used to indicate to appliances that understand the signal that the channel should be turned on or off. Within the channel could be content related to the content found on the main channel. This additional content could supplement the main content. Alternatively, the buried data stream could contain instructions for decoding the main channel. In addition, the buried data stream could contain control signals between the appliance and the data source. This control signal could alter the content in the main data channel, and could even be used to carry authorization to charge an account for accessing or altering the main data stream. The buried data channel could also be used for additional bandwidth for the signal on the main data channel, or could be used to carry content completely unrelated to the data on the main channel. In other words, the buried data stream can be used to turn on or control various features of the appliance. Revenue could be raised by selectively authorizing use of the buried data channel. This revenue can be used to reduce the cost of the wireless network components.

### BRIEF DESCRIPTION OF THE DRAWINGS

FIG. 1 is a schematic illustration of a prior art home network utilizing a prior art gateway and a media server.

FIG. 2 is a schematic illustration of a home network using a gateway of the present invention.

FIG. 3 is a schematic illustration of a network and the related data streams used to obtain video source material over the Internet for playback on a television, where a commercial message is embedded by the content provider.

FIG. 4 is a schematic illustration of a network and the related data streams used to obtain video source material over the Internet for playback on a television, where a commercial message is embedded by the gateway of the present invention.

FIG. 5 is a schematic illustration of a network and the related data streams used to obtain HTML web page data over the Internet for playback on an Internet appliance, where a commercial message is embedded by the gateway of the present invention.

FIG. 6 is a flow chart of a methodology of the present invention using advertising revenue to subsidize the cost of the gateway and adapters used in the present invention.

FIG. 7 is a schematic illustration of a network and related data streams showing the possible sources and locations for combining data streams and the different modes of operation of the appliances.

FIG. 8 is a schematic illustration of the system of the present invention showing the utilization of a central authority to control which appliances have access to the hidden data stream.

FIG. 9 is a flow chart of a first method using the ability to control access to the hidden data stream as a source of revenue generation to subsidize the cost of network components.

FIG. 10 is a flow chart of a second method using the ability to control the power to embed a hidden data stream in a combined data stream as a source of revenue generation to subsidize the cost of network components.

### DETAILED DESCRIPTION OF PREFERRED EMBODIMENTS

Preferred Wireless Data Protocol and Data Burying Capability

The present invention requires the use of wireless protocols and data burying techniques, as will be described in more detail below. These basic technologies exist in the prior art, and do not form part of the present invention. Consequently, the details of these technologies will not be described. However, the method of combining these technologies and the use to which the technologies are placed do form a part of the present invention, and will be described in detail below.

It is preferred that the wireless protocol used by the present invention be a high bandwidth protocol capable of supporting multiple channels at least as wide as the 20 Mbps required by an HDTV channel. Although several developers have proposed specifications for such a wireless protocol, the preferred protocol for the present invention is the G2, or “Gigatoo,” protocol developed by Sarnoff Corporation (Princeton, N.J.). This protocol, which should be commercially available in the year 2001, provides for 50 separate 40 Mbps channels, for a total capacity of 2 Gbps. The protocol uses confidential, patent pending technologies to provide this wireless bandwidth, including the use of multiple antennas to combat multi-path distortion.

The G2 protocol operates in the Unlicensed National Information Infrastructure (U-NII) bands assigned in the 5.6 GHz region. The total U-NII bandwidth available in the region is 300 MHz. Since a single G2 channel operates within a 6 MHz bandwidth, up to 50 G2 two-way wireless channels can operate concurrently.

The G2 protocol includes compensation for Doppler distortions of up to 80 Hz. This allows for the use of the G2 protocol with hand-held devices that are moved within the wireless coverage area during usage. The G2 protocol also allows the use of low power levels, which makes battery operated use feasible.

The data burying technique used in the present invention is basically a method for combining two channels or data streams together into a single data stream. Numerous techniques presently exist for achieving this result, including basic frequency and time-division multiplexing techniques. Basic multiplexing techniques are not preferred, however, since they are easily detectable. Once detected, it is relatively easy to filter out one of the combined data streams if the stream is undesired. Consequently, the present invention utilizes a technique for burying a data stream within another data stream in a manner that is not easily detected.

Sarnoff Corporation has developed one such technique. The Sarnoff data burying technique works, in part, by taking advantage of the redundantly coded syntax element values in MPEG and MPEG-like bitstreams. MPEG-like bitstreams are bitstream definitions accepted by basic industry groups for the compression, coding, and digital transmission of audio and visual data. In the MPEG-2 bitstream definition, one of the coded syntax element values is overriding. The Sarnoff technique includes mandatorily coding the syntax element overriding value and replacing the non-overriding syntax element value with the data to be buried. This technique is particularly useful for the present invention since it does not noticeably corrupt or otherwise alter the general usability of the main content of the MPEG bitstream. The Sarnoff techniques allow the creation of a 90 Mbps buried data stream within a 2 Gbps MPEG-2 stream. This data burying technique also uses confidential, patent pending technologies.

Although the present invention will be described below using the G2 wireless technology and the Sarnoff data burying techniques, other techniques could be used without exceeding the scope of the present invention. For instance, any wireless technology with sufficient bandwidth to transfer high definition video signals could be utilized in place of the G2 technology. In addition, other techniques for burying or otherwise combining data streams could be utilized to merge the commerce data stream with a requested content data stream. This, of course, does not mean that the combination of the G2 wireless technology and the Sarnoff data burying technique in the way described below does not create an unexpected, synergistic result.

Prior Art Home Network

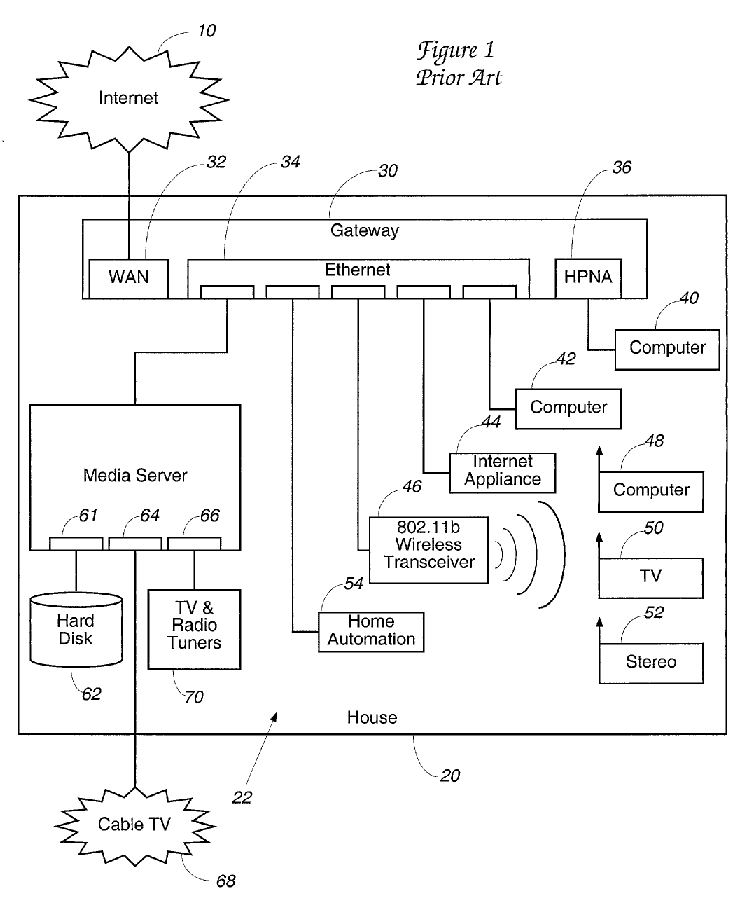

As an understanding of the basic technology and functionality of a home network is important to an understanding the present invention, this detailed description of the invention begins with a description of the prior art. FIG. 1 shows an example of access to the Internet 10 for a house 20 using an Internet gateway 30, such as is already contemplated in the prior art. This prior art gateway 30 serves as the primary linkage between appliances in the house 10 and the Internet 10. The gateway 30 has a WAN interface 32, such as an ADSL interface, multiple Ethernet ports 34, and other access ports such as a Home Phone Networking Alliance (HPNA) interface 36. The HPNA interface 36 follows the HPNA architecture to allow networking to a computer 40 through the existing home phone wiring. Similar proposed technologies include networks of home appliances communicating through the existing power lines already in the home.

Ethernet ports 34 can be used to connect a variety of standard computing devices such as computer 42 and Internet appliance 44 to the Internet 10. Such use of a gateway 30 to share Internet access to a variety of devices 40, 42, 44 is well established in the prior art.

It is also possible to connect a wireless LAN transceiver or base station 46 to one of the Ethernet ports 34 of the gateway 30. Such a wireless transceiver 46 allows the creation of an 11 Mbps wireless network according to IEEE standard 802.11b. Such a network can be accessed by any device with a receiver or transceiver abiding by the 802.11b standard, such as computer 48. Others have envisioned the incorporation of a 802.11b transceiver in a television set 50. This would allow Internet access from the TV 50, and perhaps even allow the TV 50 to play compressed video signals that are stored on either a computer 40 or 42, or are received from the Internet 10. Similar technology could be used to connect home stereo equipment 52 to the wireless base station 46.

It is also possible to connect home automation equipment 54 to the gateway 30. Such equipment 54 could include home security devices, which could access a security service through the Internet 10 or through the standard phone service (not shown in FIG. 1). Equipment 54 could also include controllers that can be used to control the environment in house 20. Such controllers could control lights, heating, and even automated doors and windows. Access could be provided to and from the home automation equipment 54 to external service providers and utilities through the Internet 10.

The concept of a media server 60 is also well established in the prior art. Media servers such as server 60 are generally responsible for the storage and direction of audio and visual materials in a home network. As shown in FIG. 1, a media server 60 could have Internet access through an Ethernet port 34 in gateway 30. Media servers 60 generally include a port 61 for connection to a large hard disk 62, upon which could be stored digitally encoded audio/ video materials. Alternatively, the hard disk 62 could be incorporated into the media server 60, or other storage media could be used to replace the hard disk 62. Media servers 60 will also have input ports 64, 66, such as an input 64 for traditional cable television 68, or input 66 for traditional television or radio tuners 70. Similar input ports for satellite television, DVD players and recorders, VCRs, camcorders, and digital cameras are also well established parts of media server concept.

The gateway 30, media server 60, and the other components shown in the house 20 in FIG. 1 are generally considered to form a home network 22.

Preferred Gateway including Media Server Capabilities

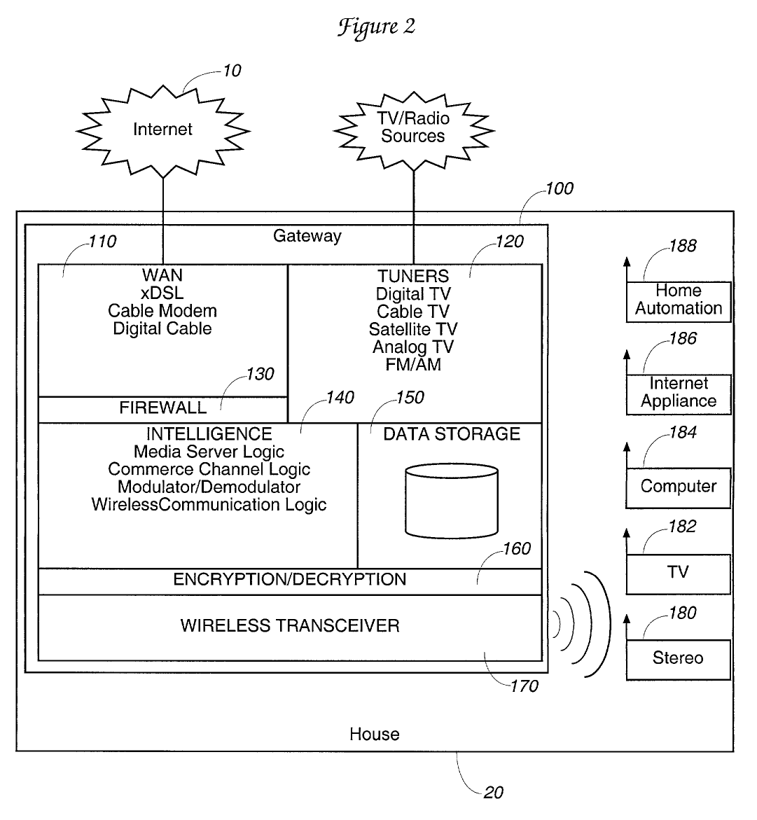

FIG. 2 shows a gateway 100 of the present invention. This gateway 100 combines the functionality of the gateway 30, media server 60, hard disk 62, and the wireless transceiver 46 of prior art FIG. 1. Although it is contemplated that these capabilities all exist within the box enclosing the gateway 100, it would be obvious to those skilled in the art that some of these functions could be moved to external components without altering the inventive concept.

The gateway 100 functions to provide access to the Internet 10 and external television and radio sources 12 to various appliances 180-188 in the house 20. In this description, the coverage area of the wireless local area network will be referred to as the house 20, even though the present invention has applicability to all areas where sponsors would be interested in sending commercial messages to individuals download digital data.

In FIG. 2, the appliances 180-188 are shown as a stereo 180, a television 182, a computer 184, an Internet appliance 186, and home automation equipment 188. These appliances 180-188 are representative only, and variations in the number, function, and variety of these appliances 180-188 are well within the scope of the present invention. In addition, although the appliances 180-188 are shown and described as devices that are physically distinct from each other, this is not a necessary condition for the present invention. In fact, the appliances 180-188 shown in FIG. 2 and the later Figures could be separate applications existing within a single device.

The gateway 100 has a WAN interface section 110 to connect to the Internet 10. This WAN interface is ideally able to manage two-way interfaces with xDSL lines and two-way digital cables. Preferably, WAN interface section 110 is able to manage multiple levels of concurrent services with a single xDSL or digital cable connection. The preferred WAN interface section 110 utilizes a Reconfigurable System on a Chip (RsoC), which provides a blend of reconfigurable and fixed functions that process transport protocols for voice, audio, videoconferencing, or video multimedia services on one DSL line. For instance, the WAN interface section 110 allows a single xDSL line to be used to handle streaming video and web access concurrently.

To interface with analog and digital television and radio sources 12, the gateway also includes a tuner section 120. This tuner section 120 contains tuner functionality to receive television signals from digital cable, digital broadcasts, satellite television, and even analog television and radio broadcast signals. In addition to receiving these signals, the preferred embodiment of the tuner section 120 includes tuners to select and receive a single channel from these sources 12. In order to allow simultaneous viewing of multiple channels from sources 12, it is necessary to include multiple tuners in the tuner section 120. Ideally, the gateway 100 will include one television tuner in the tuner section 120 for each television 182 in the house 20.

Although the preferred tuner section 120 includes the capability to decode channels from all of the sources 12 described above, it would be well within the scope of the present invention to exclude some of these capabilities. For instance, some may wish to develop a tuner section 120 without radio signal capabilities, or without the capability to receive analog signals at all. In addition, it would be well within the scope of the present invention to include tuners for different sources of audio/ video signals. Such reduced or increased functionality does not materially alter the present invention.

The preferred embodiment of gateway 100 also includes a firewall section 130. Firewall section 130 protects the house environment against undesired electronic intrusion through the WAN interface section 110, which is especially important when always-on xDSL and cable modem technologies are used for Internet access.

The intelligence 140 and data storage 150 sections contain the logic and storage necessary to allow the present invention gateway 100 to operate. One of the functions handled by these sections 140, 150 is the ability of the gateway 100 to contain the utility provided by the media server 60 and hard disk 62 described above in connection with FIG. 1. For instance, it is necessary for the gateway 100 to receive user signals that select the source and channel of video programming desired. The interpretation of such signals, and sending of requested programming is handled in section 140. In addition, it is usually necessary to decode (or demodulate) the signals stored in the data storage section 150 or received via tuner section 120. Once the signals are decoded, section 140 then must encode (or modulate) the signals in the format expected by the wireless receivers in appliances 180-188. For example, the preferred embodiment transmits all signals across transceiver 170 in MPEG-2 video bitstreams. Thus, analog television signals received from tuner section 120 must be decoded from the analog signal, and then encoded into an MPEG-2 bitstream. In this way, all analog TV signals are converted to digital, MPEG-2 bitstreams by the gateway 100.

In addition, the intelligence section 140 supports multiple protocols at the MAC layer, including video, DVD, IP, Ethernet networking, and Bluetooth protocols. This allows a wide variety of appliances 180-188 and other computing devices to be used with the gateway 100.

The intelligence section 140 can also include various technologies that improve the performance or usefulness of the tuners in tuner section 120. For instance, analog television signals are often infected with various artifacts. A COMB filter can be included in intelligence section 140 to filter out some of these artifacts before the television signal is sent to one or more of the appliances 180-188.

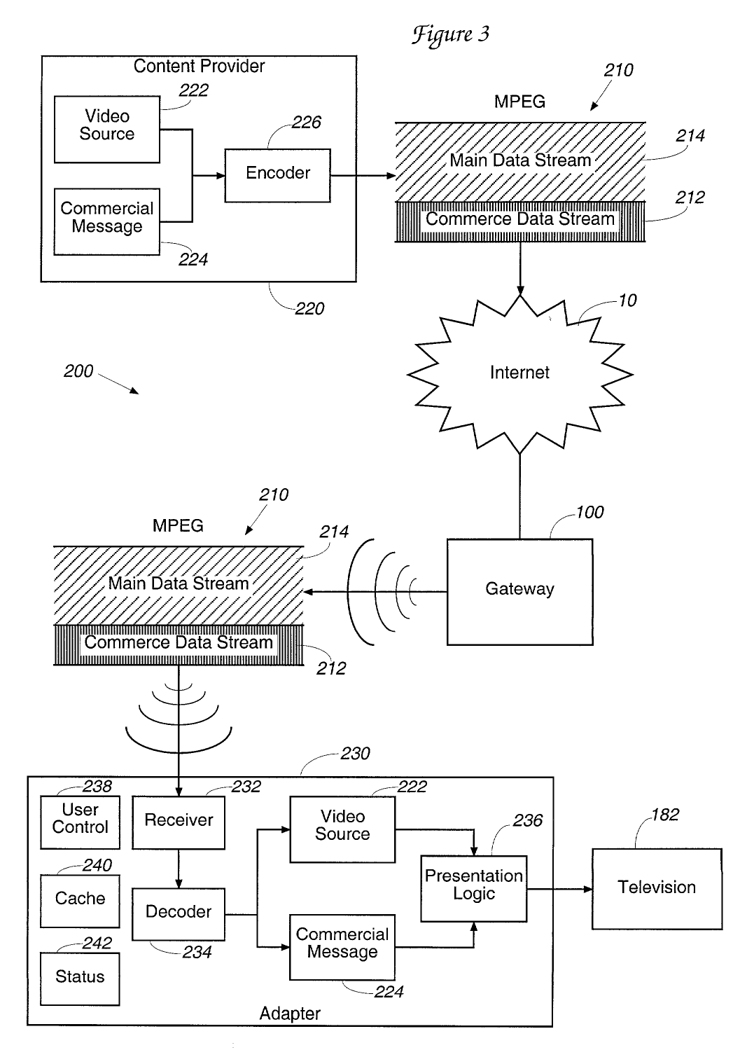

Finally, this section 140 also contains the logic necessary to encode the commerce channel within the house 20. The commerce channel, and the logic associated with it, is described in more detail below in connection with FIGS. 3 through 5.

Encryption/decryption section 160 ensures privacy for the wireless network in the house 20. This section 160 automatically encrypts data meant for appliances 180-188, and decrypts data received from the appliances 180-188. This helps maintain privacy and security for networks in neighborhoods where the reach of the wireless transceiver 170 and the appliances 180-188 extends beyond the boundaries of house 20.

Wireless transmitter 170 is responsible for the transmission of data to appliances 180-188, and for receiving data from the appliances 180-188. It is possible to use the IEEE 802.11b standard for the wireless transceiver 170, although the preferred embodiment uses the higher bandwidth G2 system as described above. The use of a higher bandwidth allows the allocation of separate channels to each of the appliances 180-188 within the house. For instance, the preferred G2 system has the capacity to handle fifty separate channels, with each channel carrying up to 40 Mbps, for a total capacity of 2 Gbps. Since 20 Mbps is the necessary capacity to carry an HDTV signal, this channel capacity allows each channel to carry two full HDTV signals. The use of fifty channels also allows the appliances 180-188 the ability to negotiate with the transceiver 170 for a clear channel using a carrier sense technique similar to that used by cordless phones. The ability to negotiate allows multiple transceivers 170 to operate simultaneously within each other's range (such as in neighboring houses).

The appliances 180-188 each contain or otherwise utilize equipment that can transmit to and receive signals from the transceiver 170. This equipment must also be capable of receiving instructions from users and encoding such instructions for use by the intelligence section 140 of gateway 100. Finally, this equipment must be capable of converting the data received from the gateway 100 into data that can be handled by the appliance 180-188. For instance, MPEG-2 video streams containing a television picture must be decoded by the equipment and presented to the television 182 as the analog or digital audio/video signals normally expected by that television 182. Initially, it is likely that this equipment will take the form of an adapter physically separate from the appliance 180-188. The adapter would incorporate the antenna(s) necessary to communicate with the gateway 100, and would further include an input device such as a remote control, keyboard, or a mouse. Eventually, it is likely that appliances 180-188 would incorporate the adapter within the appliance 180-188 itself.

The Commerce Channel

FIG. 3 shows a representative network configuration 200 utilizing the present invention. In this Figure, gateway 100 is being utilized by television 182 to obtain a video signal 210 over the Internet 10. The video signal 210 in this case is received via an MPEG-2 encoded video stream 210. A content provider 220 is the provider of the video source material 222 in video signal 210. Using the present invention, the content provider 210 is able to combine a commercial message 224 with the video source material 222, and be assured that the commercial message 224 will remain with the source material 222 all the way to the end user. In the present description, the term commercial message 224 will be used to refer to all messages for which a sponsor is will to pay in order to disseminate the message to others who would not otherwise seek out that message. Thus, the term commercial message 224 would cover product and service advertisements, religious and political messages, public service type messages, and other messages of this type.

This is accomplished by using an encoder 226 which utilizes a data burying technique to combine a commerce data stream 212 with a main data stream 214 within a single data stream 210. In the preferred embodiment, this is accomplished using technology developed by Sarnoff Corporation, as described above. The resulting data stream 210 is an MPEG-2 encoded video signal. The commerce data stream 212 has been embedded in the stream 210 in what had been the redundantly coded syntax element values normally found in the MPEG bitstreams. Using the Sarnoff technique, the main data stream portion 214 of the MPEG stream 210 is unaffected, and therefore contains the whole of the video source material 222 originally provided by the content provider 220.

One of the primary benefits of the Sarnoff data burying technique is that the commerce data stream 212 embedded in the MPEG-2 stream 210 does not alter the overall usability of the stream 210. Thus, the same data stream 210 could be received by an MPEG-2 capable appliance, and the video source 222 found in the main data stream 214 could be played unaffected by the presence of the buried commerce data stream 212. This is true even if the receiving MPEG-2 appliance receiving the signal 210 was unaware of the presence of the commerce data stream 212.

Another benefit of the Sarnoff data burying technique is that the commerce data stream 212 is not easily detected and removed. As a result, it is possible to link the commerce data stream 212 with main data stream 214 with a strong assurance that no intermediaries will detect and remove the commerce data stream 212. In addition, the way in which the commerce data stream 212 is buried in the MPEG-2 stream 210 ensures that the commerce stream 212 will survive subsequent re-multiplexing as long as the video itself is not decoded to pixels.

In addition, the way the two streams 212, 214 exist simultaneously in the MPEG-2 stream makes it extremely easy to synchronize the two streams 212, 214 together. As a result, the content provider 220 can design the commercial message 224 with confidence that the message 224 will appear to the user at the correct moment during review of the video source 222.

In the case shown in FIG. 3, the MPEG video signal 210 is transmitted over the Internet 10 to the gateway 100 of the present invention. In a preferred embodiment, the gateway 100 is aware of the presence of the commerce data stream 212 in the MPEG signal 210, but does not alter the MPEG stream 210 in any way. Rather, the gateway 100 transmits the signal 210 to television 182 without altering its content 212, 214.

As discussed above, television 182 will likely receive the signal 210 from gateway 182 through an adapter, such as adapter 230 shown in FIG. 3. This adapter 230 is specially configured to receive signals from the gateway 100 and present the received signals to the television 182. Consequently, the adapter 230 must have a receiver 232 configured to receive the signals 210 from the gateway 100. In the preferred embodiment, the receiver 232 and the gateway 100 both use the Sarnoff G2 wireless protocol to receive and send wireless LAN signals.

Although not shown in FIG. 3, it is necessary for the adapter 230 to decrypt the signal 210 received from gateway 100. As mentioned above, gateway 100 encrypts all messages to appliances 180-188 before the messages are transmitted. Thus, each adapter 230 must include an ability to decrypt the messages. This decryption ability can be included in the receiver portion 232 of adapter 230. Since the receiver 232 will also likely act as a transmitter to send signals concerning the television 182 to the gateway 100, the receiver 232 should also have the ability to encrypt signals. Of course, it would be well within the scope of the invention to omit encryption capabilities in the adapter 230.

In addition to the receiver 232, the adapter 230 also contains a decoder 234 to decode the commerce data stream 212 and the main data stream 214 found in signal 210 back into the video source 222 and the commercial message 224. These two components 222 and 224 are then presented to the television 182 through presentation logic 236. The presentation logic 236 contains the converters necessary to present the data 222, 224 into a format acceptable to television 182.

In addition, the presentation logic 236 also determines how the commercial message 224 is presented to the television 182 during the viewing of the video source material 222. In the television context, possible options include a commercial interruption in which the video source material 222 is queued and interrupted by the commercial message 224, much like commercial broadcast television. Other options include a picture-in-picture presentation of the commercial message 224, a dedicated commercial area in the television picture (such as a strip on the bottom of the screen), a translucent image that allows some of the video source material 222 to be seen through the image, or even a pop-up window such as those used on web sites. In the preferred embodiment, each of these options coexist, with the commercial message 224 itself containing instructions on how the message 224 should be presented to the appliance 180-188.

The adapter 230 must also include the ability to accept user control input and to transmit such user control commands to the gateway 100, which is accomplished by user control 238. There are numerous physical methods that can be used to allow user control commands to be inputted into the adapter 230, including infrared and radio frequency remote controls, keyboards, mice, onscreen commands, and touch-screen pads. The adapter 230 can include one or more of these physical methods within user control 238 itself, or the adapter 230 can simply accept commands that were entered into the television 182 (or whatever appliance 180-188 is attached to the adapter 230).

The preferred embodiment of adapter 230 also includes a cache 240 that can be used to cache video source material 222, commercial message 224, or even signals to and from user control 238. The cache 240 can be used for a variety of purposes, such as storing commercial message information 224 so that a complete message can be accumulated before being delivered to the television 182. In this way, a cache 240 can make up for bandwidth limitations in the commerce data stream 212. The cache 24 can also hold a commercial message 224 while the presentation logic 236 is awaiting a timing signal that indicates the message 224 should be presented. Similarly, the cache 240 could be used for video source material 222 while the commercial message 224 is presented to television 182.

Finally, the adapter 230 will optionally include status information 242. The status information 242 allows the adapter 230 to operate in a variety of modes. As is explained in more detail below, it is possible for the gateway 100 to send a signal to the adapter 230 so that it no longer decodes the hidden, commercial message 224. While operating in this “off” or “dumb” mode, the adapter 230 simply passes the combined data stream 210 directly through to the presentation logic without extracting the commercial message 224. The gateway 100 can also place the adapter 230 in “on” or “normal” mode, in which the adapter 230 once again begins extracting the commercial message 224. The current state of the adapter 230 is stored in the status information 242. Status information 242 can also store other state information that is needed during the operation of the adapter 230.

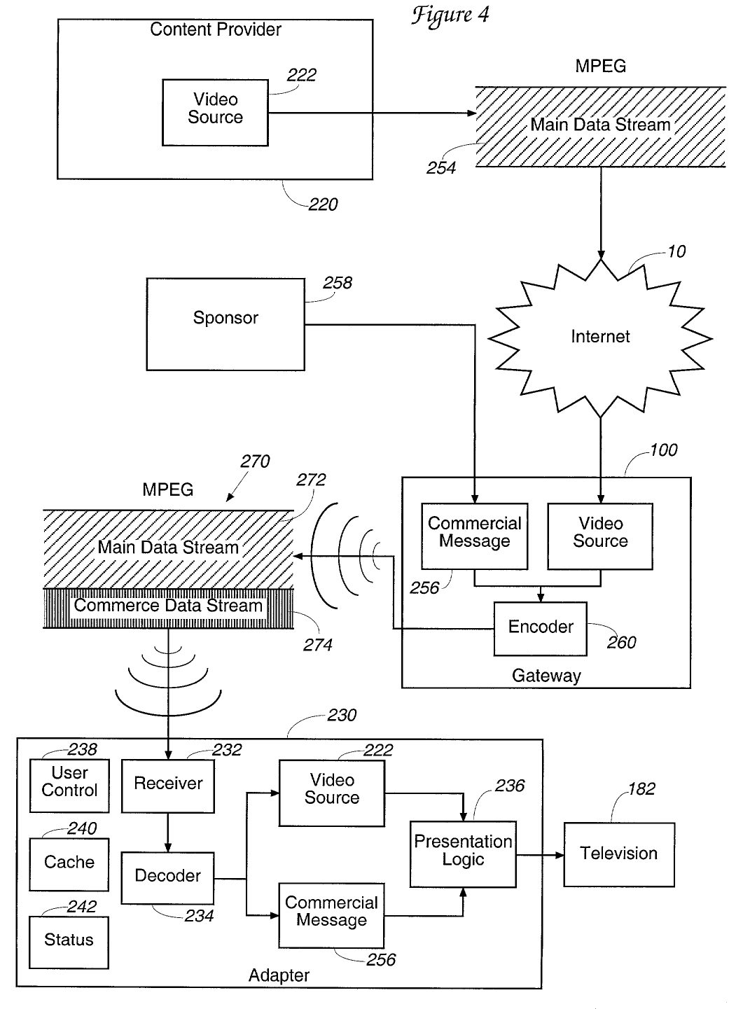

An alternative embodiment of the present invention is shown in the network configuration 250 of FIG. 4. In this Figure, the content provider 220 provides the video source material 222 without any commercial messages. Instead, the video source material 222 is sent over the Internet 10 using a standard MPEG-2 video stream 252 having only a main data stream 254.

This MPEG-2 video stream 252 is then received by the gateway 100, and is decoded back into the video source material 222. The gateway 100 then combines the source material 222 with a commercial message 256 that was provided to the gateway 100 by a sponsor 258. The sponsor 258 may be the content provider 220 itself, or may be an organization affiliated with the content provider 220. Alternatively, the sponsor 258 might not be associated with the content provider 220 in any way.

Regardless of the affiliation, the sponsor 258 has provided the gateway 100 with a commercial message 256 to be combined with the video source material 222. The commercial message 256 could be transmitted to the gateway 100 through the Internet 10, or through some other communications media such as a simple telephone connection or wireless transmission. The commercial message 256 could also be permanently stored on the storage device 150 of the gateway 100, or be provided to the gateway 100 through some removable media. Finally, rather than using one of the above methods to provide the complete content of the commercial message 256 to the gateway 100, the sponsor 258 could have used one of these methods to merely indicate how the gateway 100 should obtain the message 256. This could be accomplished simply by providing the gateway 100 with an Internet address for the desired message 256.

The gateway 100 then combines the video source material 222 and the commercial message 256 using an encoder 260 similar to the encoder 226 used by the content provider 220 shown in FIG. 3. The result of this encoding process is an MPEG-2 data stream 270 that is transmitted to the adapter 230 using the wireless LAN protocol of the gateway 100. This transmitted data stream 270 now contains the video source material 222 in the main data stream 272 (which is the same as the main data stream 254 of MPEG stream 252), and the commercial message 256 in the commerce data stream 274. The adapter 230 then uses the same techniques described above in connection with FIG. 3 to present television 182 the video source 222 and the commercial message 256.

Although the MPEG-2 video streams 210, 252, 262 are primarily designed to encode audio/video data, it is possible to encode any type of data into such a video stream 210, 252, 262. The present invention gateway 100 takes advantage of this fact by encoding all wireless communication between itself and the appliances 180-188 in MPEG-2 streams, even if the appliances 180-188 are not expecting video data. Since all wireless data transmitted from the gateway 100 is transmitted in the form of MPEG-2 streams, it is always possible to use the Sarnoff data burying technique to create a hidden commerce data stream 212, 274 in the communications to the appliances 180-188.

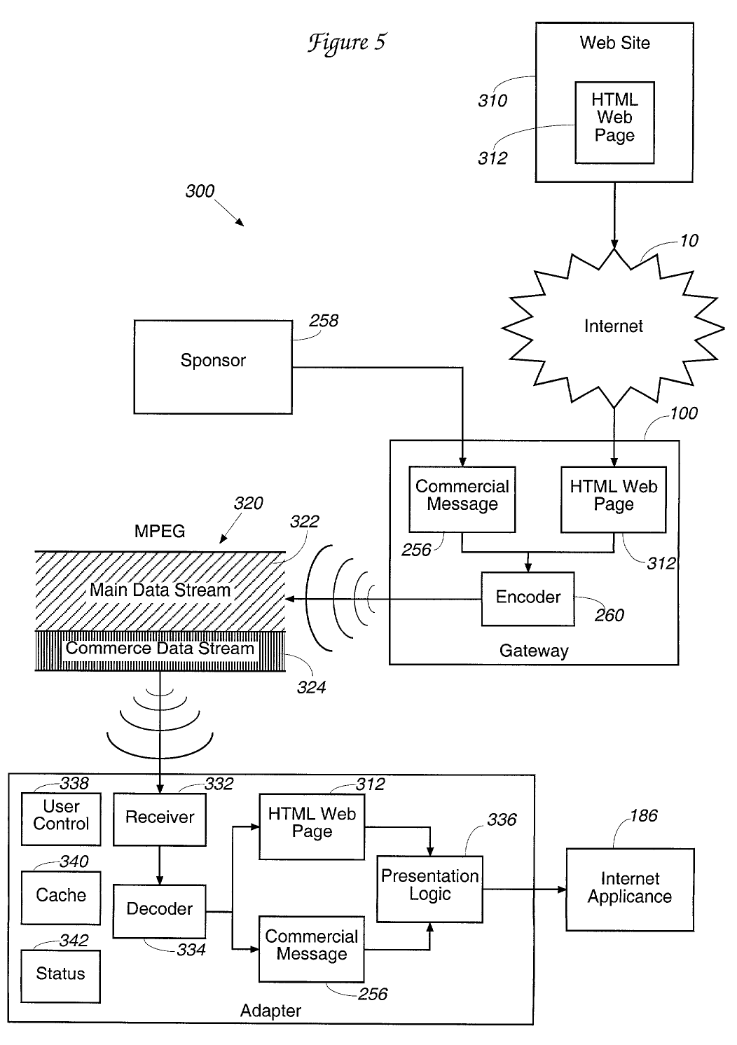

This ability is utilized in the network configuration 300 shown in FIG. 5. In this Figure, an Internet appliance 186 is being used to browse a web site 310 over the Internet 10. The html web page 312 currently being browsed is submitted to the gateway 100 over the Internet 10, and is received intact at the gateway 100.

The sponsor 258 who wishes to present a commercial message 256 to the Internet appliance 186 ensures that the gateway 100 has access to such message 256. The gateway then uses its encoder 260 to combine the HTML web page 312 and the commercial message 256 into a new MPEG-2 data stream 320. In this way, the non-video HTML traffic containing web page 312 is transmitted to the Internet appliance 186 in the main data stream 322 of the MPEG-2 stream 320, while the commercial message 256 is transmitted in the commerce data stream 324.

The Internet appliance 186 receives the data stream 320 from the gateway 100 via an adapter 330. The adapter 330 receives the data stream 320 through receiver 332. The received data stream 320 is then decoded in decoder 334 into the original HTML web page data 312 and the commercial message 256 prepared by the sponsor 258.

Up until this point, the adapter 330 is much like the adapter 230 used for television 182. Both adapters 230, 330 have a receiver 232, 332 and a decoder 234, 334, to convert the main data streams 272, 322 and the commerce data streams 274, 324 back into their original elements. In addition, both adapters 230, 330 have a user control component 238, 338, a memory cache 240, 340, and status memory 242, 342. However, the presentation logic 336 in the Internet appliance adapter 330 is much different than the presentation logic 236 of adapter 230. That adapter 230 needed to present electronic data to a television 182, and therefore included the converters necessary for the television 182 to display the data presented by the adapter 230. In contrast, the presentation logic 336 of adapter 330 must present data to the Internet appliance 186. Hence, presentation logic 336 will present data in HTML format, and perhaps Java and any other format accepted by the Internet appliance 186.

In addition, presentation logic 336 must determine how the commercial message 256 is presented to the Internet appliance 186. For instance, the message 256 could be presented through a banner-like ad permanently attached to a section of the screen on the Internet appliance 186. The message 256 could alternatively be presented as a pop-up advertising window, an audio message, or even a streamed video advertisement running in the same or a separate window as the HTML page 312. Other possibilities exist for presenting the commercial message 256 with web page 312, and the present invention is not to be limited to any particular method. It is preferable to have the presentation logic 336 be capable of performing all known ways of combining the message 256 and web data 312 based upon instructions contained within the commercial message 256 itself. The sponsor 258 who developed the message 256 could then make the ultimate decision as to the method used for a particular message 256.

It would be possible for the web site 310 to provide the HTML web page data 312 already embedded into an MPEG data stream with a concurrent commerce data stream, much like was shown in FIG. 3. However, unlike the situation in FIG. 3 where the data was video source 222 that is normally expected to be transmitted over the Internet in an MPEG data stream, basic HTML data is not normally expected in MPEG format. Thus, if the web site 310 did embed the HTML web page 312 in an MPEG stream, the web site 310 must be certain that the end user is utilizing the present invention and can decode out the HTML data and the commerce channel. If the end user were not using the present invention, the embedded HTML data 312 would not be recognized within the MPEG data stream.

The above description shows that the present invention allows for a commercial message 224, 256 to be directly linked to certain desired data that is downloaded from the Internet. The content provider 220 can add the commercial message 224, 256 before placing the data on the Internet 10, as shown in FIG. 3. Alternatively, the gateway 100 within the home can combine the commercial message 224, 256 with the desired data, as shown in FIGS. 4 and 5. The desired data can take the form of video source materials 222 (FIGS. 3 and 4), or can take the form of any other type digital data, such as the HTML web page of FIG. 5. The commercial message 224, 256 is displayed on the appliance 180-188 according to the abilities of the appliance 180-188 and the instructions placed in the commercial message 224, 256. Clearly, the present invention provides a new methodology for attaching commercial messages 224, 256 to digitally downloaded data from the Internet.

Using the Commercial Data Stream to Subsidize Hardware

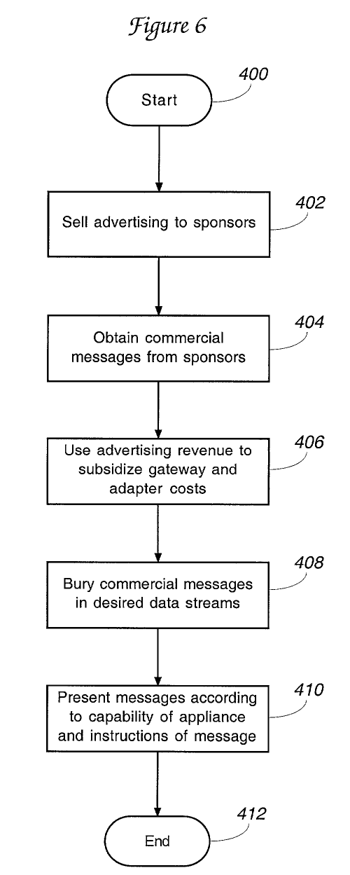

Another aspect of the present invention takes advantage of this new methodology of advertising on the Internet by obtaining revenue from advertisers and using such revenue to subsidize the cost of the gateway 100 and the adapters 230, 330. FIG. 6 shows such a methodology 400.

The first actual step 402 in methodology 400 is to sell advertising to sponsors 258. Once advertising is sold, the sponsors 258 provide commercial messages 224, 256 that are to be used with the present invention (step 404).

The advertising revenue obtained from step 402 is then used to discount the cost of the gateway 100 and the related adapters 230, 330 (step 406). It is estimated that with the use of advertising revenue generated through the use of the commerce data stream 212, 274, 324, the cost of the gateway 100 can be made directly competitive with Bluetooth 802.11(b) wireless base stations having less than one hundredth of the bandwidth of gateway 100. Of course, it may be necessary to discount the cost of the gateway 100 and related adapters 230, 330 before any advertising revenue is generated in step 402, simply in order to increase the base of gateways 100 in use.

Once a user has a gateway 100 and the required adapters 230, 330, the commercial messages 224, 256 are then buried in the desired data streams in step 408. The details of this step 408 are described above. The buried commercial messages 224, 256 are then presented to the end user according to the capability of the appliance 180-188 being used by the end user, and according to the instructions in the commercial message 224, 256 itself. (step 410). The methodology then ends at step 412.

Selective Use of Buried Data Stream

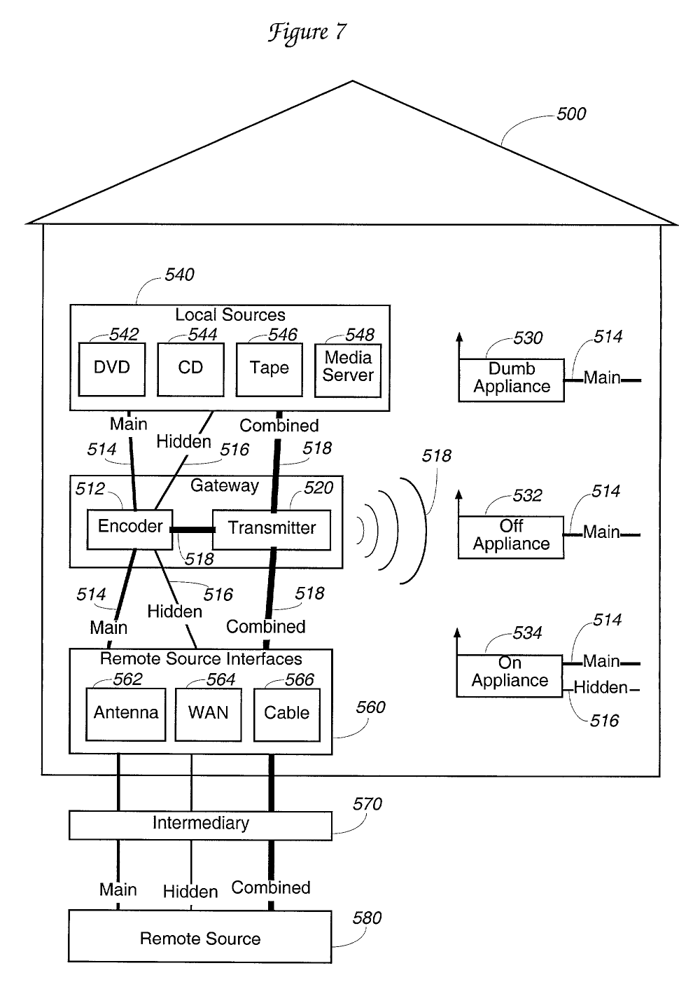

The ability to embed a hidden data stream within a wireless local area network in the home can be leveraged in numerous ways in addition to the commerce data stream described above. FIG. 7 shows a home 500 containing a wireless gateway 510 of the present invention. This gateway 510 contains an encoder 512 that is capable of combining a main data stream or channel 514 and a hidden data stream or channel 516 into a single combined stream 518. The hidden data stream 516 is buried within the combined data stream 518 as described above. Hence, it is difficult to detect the presence of the hidden data stream 516 within the combined stream 518, and the combined stream 518 can be treated as the functional equivalent of the main data stream 514. The combined data stream 518 is then submitted to the transmitter 520, which transmits the combined signal 518 to appliances 530-534 within the home 500.

The source for these signals can either be local 540 or remote 550. Local sources 540 would include devices that can play widely distributed fixed media, such as DVDs 542, music CDs 544, and audio or video tapes 546. Alternatively, a computer such as media server 548 could serve as a local source 540. Remote sources 550 will be received within the home 500 through some type of remote source interface 560, such as an antenna 562, or a WAN 564 or Cable 566 interface. The remote sources 550 will often have to enter the home 500 through an intermediary 570, such as an Internet service provider, a cable television operator, a local phone service provider, or even a local electrical or other utility.

Each of these sources 540, 550 can provide the gateway with a main signal 514 and a hidden signal 516 that will be combined by the encoder 512 in gateway 510 into the combined signal 518. The utilization of a local encoder 512 to combine two signals is described above in connection with FIG. 4. Alternatively, the local or remote sources 540, 550 can provide the gateway 510 directly with a combined signal 518. For example, a DVD manufacturer can encode on the DVD a combined signal 518 with the main channel 514 containing the traditional DVD content and the hidden channel 516 containing enhancements to the traditional content. Alternatively, the remote source 550 might transmit a combined signal 518 to the home 500 in order to prevent the intermediary 570 from monitoring or filtering the data found on the hidden channel 516. An example of a remote source 550 transmitting a combined signal 518 is described above in connection with FIG. 3.

The combined stream 518 can be considered the functional equivalent of the main data stream 514. Thus, a receiving device can be completely unaware of the hidden data stream 516 and will still be able to use the main data stream 514. An example of such a receiving device is the dumb appliance 530 shown in FIG. 7. This appliance 530 is able to receive the combined data stream 518, but is unaware of the presence of the hidden data 516. Hence, the dumb appliance 530 will detect only the main data stream 514, and will only be able to utilize that data.

Appliances 532 and 534 can both be considered “smart” appliances in that they contain circuitry and/or programming that allows them to separate the received combined data stream 518 into main 514 and hidden 516 data. However, in the present invention it is possible to have an appliance operating in an “off” mode, such as the off appliance 532 shown in FIG. 7. In such a mode, the off appliance 532 would operate as if it were a dumb appliance, and would extract only the main data 514 within the data stream. In contrast, the appliance 534 that is operating in the “on” mode will be able to extract both the main data stream 514 and the hidden data stream 516 from the combined signal 518 transmitted by the gateway 510.

The appliances 532-534 that are capable of decoding the buried, hidden signal 516 can be controlled by the signals transmitted by the gateway 510. Thus, the gateway 510 could signal the on appliance 534 to operate in the off mode, and the off appliance 532 to operate in the on mode. In this way, the gateway is able to selectively control which of the appliances 532-534 has access to the data in the hidden data stream 516.

One way of controlling the appliance 532-534 in this remote fashion is to use some of the hidden data channel 516 as a control signal pathway, allowing control signals to be sent to and from the remote appliances 532-534 within the home 500. Because even the off appliance 532 would need to be able to receive and respond to control signals, the off appliance 532 would utilize its circuitry to decode and monitor the embedded hidden data stream 516 even while in the off mode. However, while in off mode, the decoded hidden data stream 516 would not be used for any purposes except for monitoring the data stream 516 for control signals directed to that particular appliance 532.

In order to selectively send control signals to a particular appliance 532-534, the control signal would have to contain a unique address identifying the appliance 532-534. Since the reach of the transmissions made by the gateway 510 would be geographically limited, it would only be necessary for each appliance 532-534 to be uniquely addressed within the local reach of transmitter 520. However, it would be more advantageous to have each appliance to be uniquely addressed within the world, such as is provided with Ethernet MAC addresses. By providing a globally unique identifier, it would not be necessary to ensure that no two devices in the same network share the same address.

A globally unique identifier would also allow a more centralized control over the appliances 532, 534. For instance, a remote source 550 would be able to selectively control which appliances 532-534 are able to access and utilize the hidden channel 516 within its combined data stream 518. Alternatively, the gateway 510 could selectively maintain control over when and how the appliances 532-534 operate in connection with the hidden channel 516. Since the gateway 510 could be centrally controlled via the WAN interface 564, one central authority could control when the devices 532-534 accessed the hidden channels 516, much like a cable television provider can remotely control access to channels via cable converter boxes within the home.

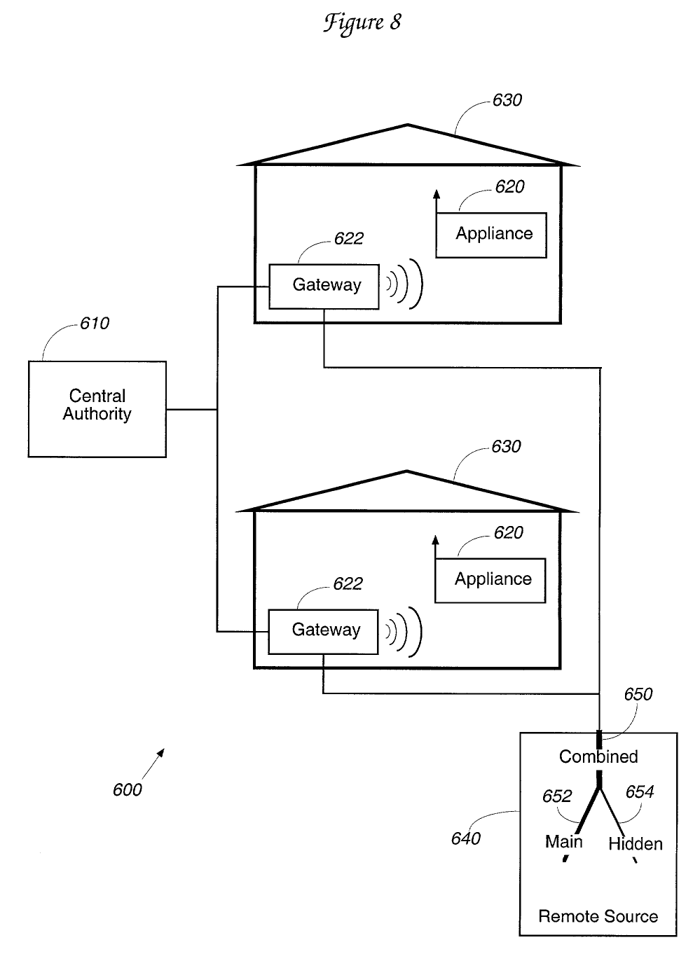

This ability can be leveraged in a variety of ways. FIG. 8 shows an environment 600 where a central authority 610 controls the status of appliances 620 in a variety of homes 630. Although it is not shown in FIG. 8, these appliances 620 contain or are connected to adapters, such as adapter 230 shown in FIG. 4. A remote source 640 provides a combined signal 650 that is accessible from each of the homes 630 and is transmitted within the home 630 to the appliances 620 via gateways 622. The combined signal 650 contains a main channel 652 and a hidden channel 654. The remote source 640 may communicate with the central authority 610 to help determine which appliances 620 in which homes 630 are allowed to access the hidden channel 654.

The hidden channel 654 can be used for a variety of purposes in this environment 600. For instance, the hidden channel 654 can provide content that supplements the content in the main channel 652. As an example, music provided on a main channel 652 could be supplemented with additional information about the music on the hidden channel 654, such as lyrics or background information on the artist. Alternatively, a main channel 652 having video could have related interactive content on the hidden channel 654, such as a “guess the next play” game for a broadcast of a sporting event.

In addition, the hidden channel 654 can be used to provide and control access to the main channel 652. For example, the main channel 652 may present music videos to a television screen, while the hidden channel 654 allows the user to search and select the video being displayed. The hidden channel 654 could also allow the user to control the violence or sexual content level of the main channel 652, or to overlay the main channel 652 with catchy phrases and interesting facts relating to the current content of the main channel 652.

It is also possible to encrypt the main channel 652, and place the decryption key for the main channel 652 on the hidden channel 654. The appliance 620 receiving the encrypted main channel 652 would have to access the hidden channel 654 before the main channel 652 could be decrypted. In addition, since the decryption key is provided in parallel with the encrypted content, it is possible to vary the decryption key over time and thereby increase the security of the encryption.

This type of versatility is possible because the hidden channel 654 is simply a digital communications channel. As a result, it can carry within it the instructions for its use. For instance, in the example of carrying a decryption key for the main channel 652, the instructions for how the main channel 652 is to be decrypted can be contained within the hidden channel 654 itself. Thus, not only the decryption key would be found in the hidden channel 654, but the entire decryption algorithm could be transmitted as well. In this way, it would not be necessary to provide each of the appliances 620 with built in decryption abilities. Rather, a general purpose CPU can be provided in each appliance 620 that is capable of receiving instructions from the hidden channel 654 and executing those instructions.

This same versatility could be utilized to create a pay-per-use type of system in which the main channel 652 is accessible only after the user has paid for that access. This is easily accomplished because the appliances 620 can contain a user control component 238, 338, as described above, that is capable of interaction with the user. Thus, each appliance 620 can simply receive instructions through the hidden channel 654 to present the user with an option to pay for access to the main channel 652. The user interacts with the appliance 620, which transmits the user's response back to the gateway 622. The gateway 622 can then authorize the central authority 610 or remote source 640 to charge the user's credit card, and then can instruct the appliance 620 to allow the user to decrypt the main channel 652. Alternatively, the hidden channel 654 could provide an uninterrupted communications path from the appliance 620 through the gateway 622 to the remote source 640. The same payment authorization can be used to allow the user to access the content on the hidden channel 654 while providing free, unencrypted access to the main channel 652.

One way of generalizing the above examples is that the hidden channel 654 is used to turn features of the appliance 620 on and off. For instance, the appliance 620 may have the ability to provide background information on a currently playing music video, or to provide access to encrypted content coming through the main channel 652. These features can be either pre-programmed into the appliance 620, or can be programmed using instructions buried in the hidden channel 654. Either way, these features are enabled or disabled by controlling the ability to access the hidden channel 654. Dumb appliances 530, or smart appliances operating in off mode 532, would not have the ability to use or control such features, since these appliances 530, 532 do not have access to the hidden channel 654.

The above environment 600 can also be used to allow the central authority 610 to otherwise monitor, meter, and control access to the bandwidth found in the hidden channel 654. The default condition of the appliances 620 could be the off condition, in which the combined data signal 650 is treated as if it is comprised only of the main data channel 652. The bandwidth of the hidden data channel 654 exists in this system, but can only be turned on through the central authority 610 or through other intelligence built into the gateways 622 or appliances 620. The bandwidth is then offered to third parties and home owners in exchange for a fee paid to the central authority 610 or other party with the ability to turn on access to the hidden channel 654. The bandwidth could be used for a variety of purposes, including the provision of appliance features set forth above.

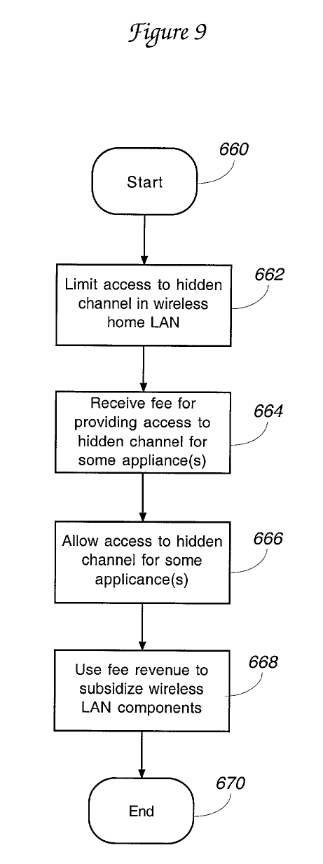

The fees collected for this bandwidth or for the ability to turn on appliance features could then be utilized to subsidize the cost of the wireless network components, such as the appliances 620 and gateways 622. FIG. 9 sets forth a method 660 in which these revenues are used in this way. Step 662 of this method 660 serves to limit access to the hidden data stream 654 by the various appliances 620. In other words, the appliances 620 operate in off mode to prevent access to the hidden data stream 654 unless such access has been specifically authorized.

In step 664, a fee is received for allowing some appliances 620 to access the hidden data 654. Consequently, the appliances 620 for which a fee has been paid are allowed to access the hidden data stream 654 in step 666. The revenue generated by this method 660 can then be used to subsidize the components needed to set up the local wireless area network in the homes 630 in step 668. Specifically, the revenues can be used to lower the price of the gateways 622 and the appliances 620 and/ or the adapters used by the appliances 620 to receive the wireless signals. The method then ends at step 670.

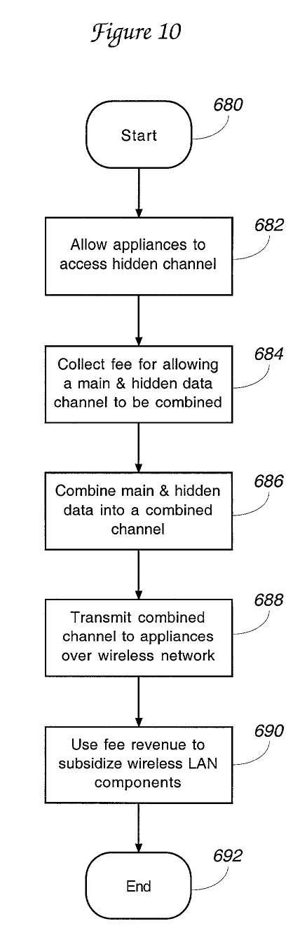

The method 660 of FIG. 9 generates revenue by switching on access to the hidden data stream 654 at particular appliances 620, thereby either creating additional bandwidth for the appliance 620 or enabling a feature of the appliance 620 that was previously unavailable. It is also possible to generate revenue by controlling the ability to combine a hidden data stream 654 with a main data stream 652 into a combined data stream 650, as is shown in method 680 of FIG. 10. This method 680 starts with the supposition that some appliances 620 exist that are capable of extracting the hidden data stream 654 from the combined data stream 650, as shown is step 682. Revenue is collected by controlling the ability to combine hidden 654 and main 652 data streams (step 684). After the revenue has been received or promised, the data streams 652, 654 are merged into the combined data stream 650 (step 686) and then transmitted to the appliances 620 via the gateways 622 (step 688). The revenue generated is used to subsidize network components in step 690, and the method 680 then ends at step 692.

Regardless of whether revenue is generated by controlling the appliances 620 that can access the hidden data stream 654, or by controlling the ability to bury a data stream 654 in the combined stream 650, the revenue is used in methods 660 and 680 to reduce the cost of the wireless network components to the consumer. In effect, the ability to monitor, meter, and control the bandwidth in the hidden data stream 654 allows the generation of revenue, which in turn subsidizes the cost of the components 620, 622. This is turn speeds up the adoption of the wireless networking standard that contains the hidden data stream 654, which further increases the ability to obtain revenue by regulating that stream 654.

The present invention is not to be taken as limited to all of the details described above, as modifications and variations to the invention may be made without departing from the spirit or scope of the invention. For instance, the above description refers to accessing data over the Internet. Clearly, the present invention would be equally applicable to data obtained over any network, whether private or public. In addition, although the invention preferably uses the G2 wireless technology from Sarnoff Corporation and the Sarnoff data burying techniques, other technology and techniques could be utilized without departing from the scope of the present invention. Also, although the adapters 230, 330 were discussed only in connection with a television 182 and an Internet appliance 186, it is an expected part of the present invention to develop adapters for the other appliances shown in FIG. 2, in addition to the numerous appliances not shown in the Figures, whether currently known or not. Finally, although the above discussion described wireless networks in a “house,” “home,” or “household,” the present invention is equally applicable in offices, warehouses, factories, airports, hotels, plazas, city parks, or any other location where sponsors would be interested in sending commercial messages to end users downloading digital data over a network. Because many such options are present, the scope of the present invention is not to be limited to the above description, but rather is to be limited only by the following claims.

What is claimed is:

1) A method for financially subsidizing network components comprising:
a) combining a commercial message in a combined data stream that also contains a desired digital signal, the commercial message being buried in the combined data streamed such that the combined data stream is the functional equivalent of the desired digital signal;
b) transmitting the combined data stream at a wireless local area network transmitter;
c) decoding the commercial message from the combined data stream at an adapter that can present the desired digital signal to an appliance;
d) obtaining revenue for distributing the commercial message; and
e) using the revenue to subsidize the price of at least one of the group consisting of the transmitter, the adapter, and the appliance.

2) A system for controlling access to a hidden data stream embedded in a combined data stream transmitted over a wireless local area network, the system comprising:
a) a receiving apparatus having
i) a receiver for receiving the transmitted combined data stream;
ii) a decoder that decodes the combined data stream into a main data stream and the hidden data stream;
iii) a status component that indicates whether the decoder operates to decode the hidden data stream from the combined data stream
b) a gateway having a transmitter for transmitting the combined data stream and for transmitting instructions to the receiving apparatus that changes the status component, thereby controlling whether the decoder operates to decode the hidden data stream.

3) The system of claim 2), wherein the gateway contains a network interface, through which the gateway can receive directions to instruct the receiving apparatus to change status.

4) The system of claim 3), wherein the receiving apparatus has a unique address, and further wherein the directions received by the gateway refer to the unique address of the receiving apparatus, whereby the receiving apparatus responds only to instructions containing its address.

5) The system of claim 4), wherein the unique address of the receiving apparatus is unique throughout the world.

6) A system for controlling access to a hidden data stream buried within a combined data stream comprising:
a) an encoder for combining the hidden data stream with a main data stream into the combined data stream, the combined data stream operating as a functional equivalent of the main data stream; and
b) a plurality of local locations, each local location having
i) a gateway for transmitting a wireless local area network signal, the wireless signal containing the combined data stream and a control signal; and
ii) at least one appliance having an adapter for receiving the wireless signal, the adapter having
(1) a receiver for receiving the wireless signal containing the combined data stream;
(2) a decoder capable of decoding the combined data stream into the hidden data stream and the main data stream; and
(3) a status memory for determining whether the apparatus is in a first state where the received wireless signal is decoded into the hidden data stream and the main data stream, or is in a second state where the received wireless signal is presented to the appliance without decoding, the state of the status memory being controllable by the control signal.

7) The system of claim 6), wherein the control signal is found within the hidden data stream.

8) The system of claim 6), wherein each adapter has a unique address, and further wherein the control signal identifies the adapter for which it is intended via the unique address of the adapter.

9) The system of claim 6), wherein the main data stream is encrypted, and further wherein a decryption key needed to decrypt the main data stream is within the hidden data stream.

10) The system of claim 9), wherein the hidden data stream further contains instructions explaining how the decryption key can be used to decrypt the main data stream.

11) The system of claim 9), wherein the hidden data stream further contains instructions used to present an end user with an option to pay for access to the main channel, whereby the main data stream is not decrypted until the user elects to pay for access.

12) The system of claim 6), wherein the hidden data stream contains content that supplements content found on the main data stream.

13) The system of claim 6), wherein the hidden data stream contains control messaging information to control content found on the main data stream.

14) The system of claim 6), where the hidden data stream controls access to a feature of the appliance.

15) The system of claim 6), further comprising:
c) a central authority in communication with each of the gateways, the central authority being capable of requesting that the gateways send a signal to one or more adapters to change their status memory between states.

16) The system of claim 15), wherein each adapter has a unique address, wherein the control signal identifies the adapter for which it is intended via the unique address of the adapter, and further wherein the central authority instructs the gateways to switch the state of at least one adapter identified by its unique address.

17) The system of claim 16), further comprising a remote source in communication with the gateways, the remote source providing the combined data stream to the gateways.

18) The system of claim 17), wherein the central authority does not authorize the gateways to access the hidden channel unless the remote source arranges payment to the central authority for such access.

19) A method for subsidizing the cost of wireless local area network components comprising:
a) transmitting a combined data stream over a wireless local area network, the combined data stream having a main data stream and a hidden data stream, the hidden data stream being buried within the combined data stream such that the hidden data stream is not easily detectable within the combined data stream and such that the combined data stream is a functional equivalent of the main data stream;
b) receiving the combined data stream at an appliance;
c) selectively decoding the combined data stream at the appliance such that when the combined data stream is decoded, the hidden data stream is accessible and the main data stream is forwarded to the appliance, and that when the combined data stream is not decoded the combined data stream is sent directly to the appliance and the hidden data stream is inaccessible;
d) receiving revenue for allowing access to the hidden data stream at the appliance; and
e) utilizing the revenue to subsidize the cost of the components used to transmit and receive the combined data stream.
